(19) United States
(12) Patent Application Publication
(10) Pub. No.: US 2008/0186354 A1
(43) Pub. Date: Aug. 7, 2008

(54) METHODS, APPARATUS AND SYSTEMS FOR INCREASING THROUGHPUT USING MULTIPLE PRINT HEADS ROTATABLE ABOUT A COMMON AXIS

(76) Inventor: John M. White, Hayward, CA (US)

Correspondence Address: DUGAN & DUGAN, PC, 245 Saw Mill River Road, Suite 309, Hawthorne, NY, 10532, US

(21) Appl. No.: 12/013,399

(22) Filed: Jan. 11, 2008

Related U.S. Application Data
(60) Provisional application No. 60/884,599, filed on Jan. 11, 2007.

(51) Int. Cl. B41J 23/00

(52) U.S. Cl. 347/38

(57) ABSTRACT

Apparatus and methods for printing are provided. A printing apparatus includes a platform adapted to rotate about a rotational axis and a plurality of longitudinally aligned print heads coupled to the platform. In one or more embodiments, each of the plurality of print heads includes a set of nozzles arranged in a line having a nozzle line length and the print heads are separated longitudinally by a clearing distance equal to approximately an integer times the nozzle line length.

The present application claims priority to U.S. Provisional Patent Application No. 60/884,599, filed Jan. 11, 2007 and entitled “METHODS, APPARATUS AND SYSTEMS FOR INCREASING THROUGHPUT USING MULTIPLE PRINT HEADS ROTATABLE ABOUT A COMMON AXIS,” which is hereby incorporated by reference herein in its entirety.

### CROSS REFERENCE TO RELATED APPLICATIONS

The present application is also related to the following commonly-assigned, co-pending U.S. patent application, which is hereby incorporated by reference herein in its entirety:

U.S. patent application Ser. No. 11/212,043, filed Aug. 25, 2005 and titled “Methods and Apparatus for Aligning Inkjet Print Head Supports” (Attorney Docket No. 10242).

### FIELD OF THE INVENTION

The present invention relates generally to inkjet printing systems that may be employed during flat panel display manufacturing, and is more particularly concerned with apparatus and methods for increasing throughput by employing at least two inkjet print heads rotatable around a common axis on a printing carriage.

### BACKGROUND OF THE INVENTION

Inkjet printing is currently being used as a technique for manufacturing flat panel displays and in particular in the formation of color filters used in such displays. One problem with effective employment of inkjet printing is that it is difficult to dispense ink or other materials accurately and precisely on a substrate while having a high-throughput. Thus, what is needed are systems, methods and apparatus for increasing throughput of inkjet printing systems.

### SUMMARY OF THE INVENTION

In some aspects, the invention provides a printing apparatus including a platform adapted to rotate about a rotational axis and a plurality of longitudinally aligned print heads coupled to the platform. In one or more embodiments, each of the plurality of print heads includes a set of nozzles arranged in a line having a nozzle line length and the print heads are separated longitudinally by a clearing distance approximately equal to an integer times the nozzle line length.

In some other aspects, the invention provides an inkjet printing system for manufacturing color filters which includes a frame; a stage coupled to the frame and adapted to move a substrate in a print direction; a print support coupled to the frame and adapted to support a plurality of print carriages, wherein the carriages are adapted to be moved along the print support; a plurality of platforms, each one coupled to a different one of the print carriages and each adapted to rotate about a different respective rotational axis; and a plurality of sets of print heads, each one of the sets coupled to a different one of the platforms and each set including a plurality of longitudinally aligned print heads.

In yet other aspects, the invention provides a method of depositing ink on a substrate for manufacturing a color filter. The method includes longitudinally aligning a plurality of print heads on a platform; rotating the platform about a rotational axis to bring the print heads to a desired saber angle; and depositing ink from the print heads in a first print pass on a substrate moving in a first print direction below the print heads.

Other features and aspects of the present invention will become more fully apparent from the following detailed description of exemplary embodiments, the appended claims and the accompanying drawings.

### BRIEF DESCRIPTION OF THE DRAWINGS

FIG. 1 is a side elevational view of an exemplary embodiment of an ink jet print system according to embodiments of the present invention.

FIG. 2 is a front elevational view of an exemplary printing carriage provided according to embodiments of the present invention.

FIG. 3 is a bottom elevational view of an exemplary print carriage including two print heads provided according to embodiments of the present invention.

FIG. 4A illustrates an example first print pass using a print carriage including two print heads as shown in FIG. 3 in which a clearing spacing between print heads as provided according to the present invention is optimal.

FIG. 4B illustrates an example second print pass using a print carriage including two print heads in which a clearing spacing between print heads as provided according to the present invention is optimal.

FIG. 5A illustrates an example first print pass using a print carriage including two print heads in which a clearing spacing between print heads is sub-optimal.

FIG. 5B illustrates an example second print pass using a print carriage including two print heads in which a clearing spacing between print heads is sub-optimal.

FIG. 6A is a bottom elevational view of an exemplary print carriage including two print heads provided in accordance with the present invention in which a clearing spacing between the print heads is approximately equal to twice a nozzle line length.

FIG. 6B is a bottom elevational view of an exemplary print carriage provided in accordance with the present invention including three print heads.

### DETAILED DESCRIPTION

The present invention provides apparatus and methods for improving printing throughput in a printing system by including two or more print heads in a single printing assembly with a common rotation axis, at least doubling (where two print heads are used) the number of print heads that are able to dispense ink on a substrate concurrently. In some embodiments of the present invention, one or more printer assemblies (‘carriages’) may include two or more (‘multiple’) print heads coupled to a rotatable platform (‘rotation stage’) having rotational axis. In one or more embodiments, the multiple print heads may include sets of nozzles arranged in a line, each of a set length, and may be aligned longitudinally. To provide optimal throughput, a clearing distance between the print heads may be set approximately equal to the set length of the lines of nozzles. In various embodiments, the print heads may used to dispense ink concurrently, sequentially or in any combination(s) thereof.

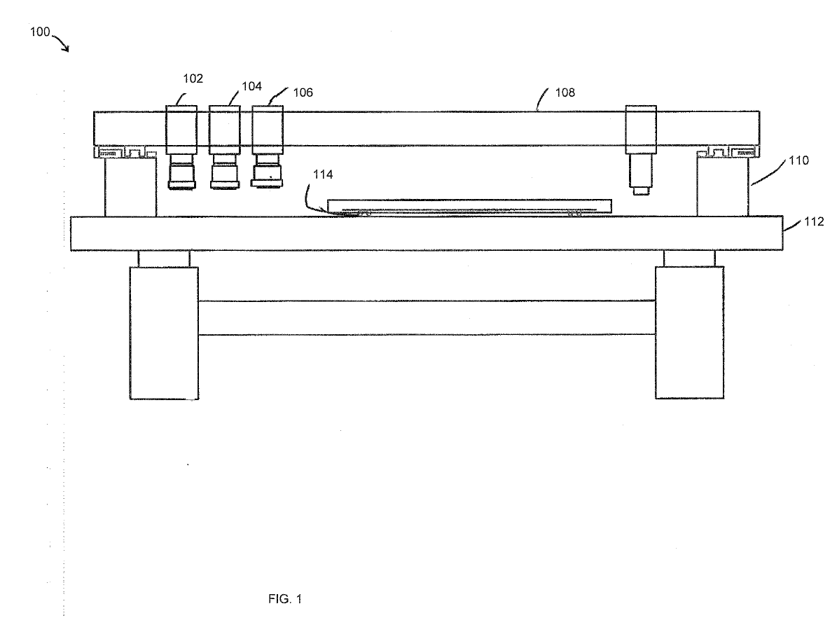

FIG. 1 illustrates a side elevational view of an exemplary inkjet printing system (e.g., suitable for manufacturing color filters for flat panel displays) in which the apparatus and methods of the present invention may be applied. The printing system is designated generally by the reference number 100. The inkjet printing system 100 may include a plurality of print head carriages 102, 104, 106 arranged on a print head support 108 or bridge. It is noted that a larger or smaller number of carriages (e.g., one, two, four, five, etc.) may be used. A larger number of supports may also be used to each support multiple carriages. The print head support 108 may rest on a frame 110, which, in turn, may be supported on a frame table 112. The ink jet printing system 100 may also include a movable support stage 114 that may support and convey a substrate. The frame table 112 and stage 114 define a horizontal (X-Y) reference plane. In this plane, the direction of stage motion, or the printing direction, is in the Y-axis direction (for example, as the system is represented in FIG. 1, the Y-axis extends into and out of the plane of the page perpendicular to the plane of the page). The print head support 108 may be aligned perpendicular to the printing direction along the X-axis of the reference frame, or may be angled with respect to the X-axis. When the print head support 108 is angled, the print head carriages 102, 104, 106 may be moved or indexed along the print head support 108. The movement of the print head carriages 102, 104, 106 along the support 108 may be controlled by at least one controller (not shown).

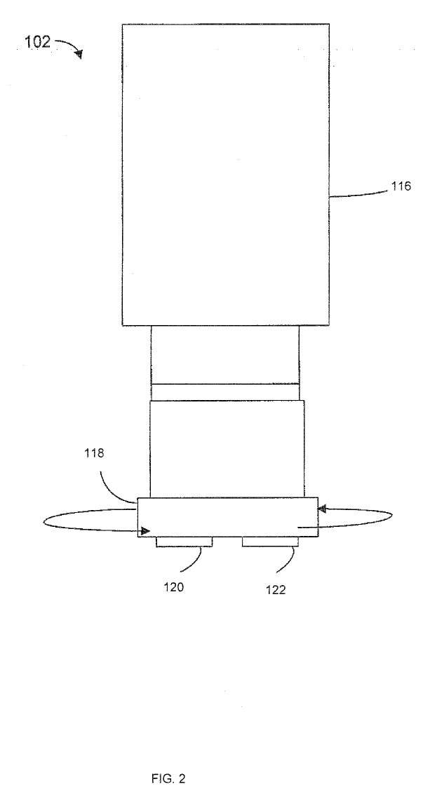

As shown in FIG. 2, which is a close-up schematic block diagram of a print head carriage provided according to the present invention, e.g., carriage 102 in FIG. 1, a print carriage 102 may include a driver 116, a rotation stage platform 118, and multiple (e.g., in the depicted example, two) print heads 120, 122. In one or more embodiments, the driver 116 may include electronic components adapted to control motion and/or operation of the rotation stage platform 118 and/or the print heads 120, 122. However, in alternative embodiments, such components, or portions thereof, may be located outside of the driver 116. The rotation stage platform 118 is rotatably coupled within the print head carriage 102 (e.g., via bearings, washers, etc.) and driven by a motor (not shown) to rotate in a plane (indicated by arrows) around a (generally) vertical axis which may, for example, be coincident with the central vertical axis of the rotation stage platform 118. The print heads 120, 122, are coupled to a lower surface of the rotation stage platform 118.

In operation, the angular orientation of the print heads 120, 122 in the horizontal (X-Y) plane, termed the ‘saber’ angle, may be set by controlling rotation of the rotation stage platform 118. In some embodiments, the saber angle may be set by the driver 116 and/or an external control. By altering the saber angle, the printing pitch (e.g., the distance in the X-direction between ink drops deposited by adjacent print head nozzles) may be controlled.

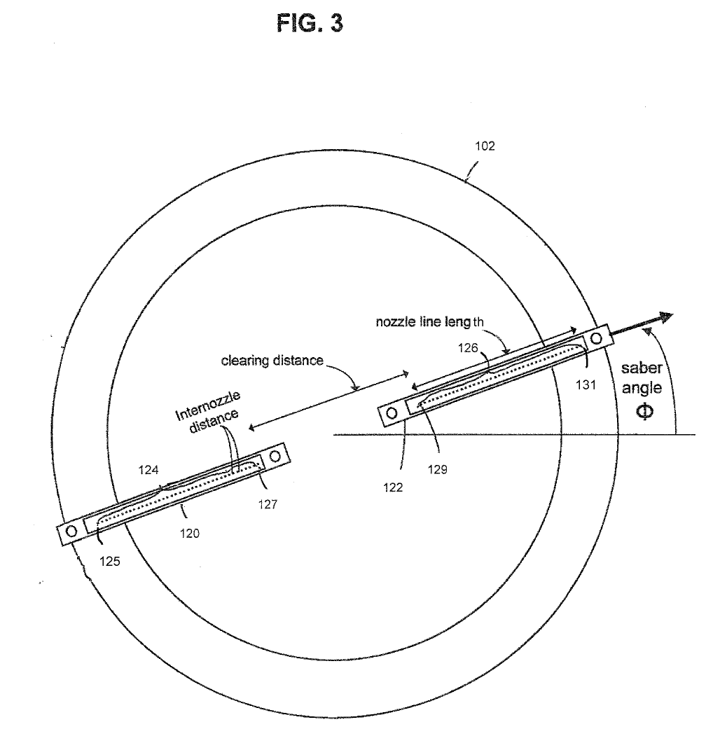

FIG. 3 is a bottom schematic view of an example print head carriage provided according to embodiments of the present invention including first and second print heads 120, 122. The print heads may be embodied as, for example, a Model SE-128 print head manufactured by Dimatix Inc. of Lebanon, N.H. which includes 128 channels and corresponding nozzles. The first print head 120 includes a nozzle plate having a first set of linearly arranged nozzles 124, extending from a first end nozzle 125 to a second end nozzle 127, and the second print head 122 includes a nozzle plate having a second set of linearly arranged nozzles 126, extending from a first end nozzle 129 to a second end nozzle 131. As shown, in one or more embodiments, the first and second print heads 120, 122 are longitudinally aligned, meaning that both sets of nozzles 124, 126 are arranged along the trajectory of a single line. In alternative embodiments, the first and second print heads 120, 122 and their respective sets of nozzles 124, 126 may be arranged otherwise, for example, in parallel but not precisely aligned. As noted above, the print heads 120, 122 may be longitudinally aligned at a saber angle(Φ) with respect to the X-Y plane defined by the frame table 112 and support stage 114.

In some embodiments, the nozzles within each of the sets 124, 126 may be equally spaced from one another by an internozzle distance (IND). Thus, in this case, the total nozzle line length (NLL) of each of the sets is equal to the number of nozzles (n) in each set 124, 126 minus 1 (n−1) times the internozzle distance (IND).

NLL=(n−1)·IND

In one or more embodiments of the present invention, the first and second print heads 120, 122 may be arranged so that they are spaced apart in their longitudinal dimension such that the distance between the second end nozzle 127 of the first print head 120 and the first end nozzle 129 of the second print head 122, is (approximately) an integer number (i) times the nozzle line length (NLL). In the exemplary embodiment shown in FIG. 3, the integer number is one (i=1), and the distance between the second end nozzle 127 and the first end nozzle 129 (the ‘clearing distance’) is set approximately equal to the nozzle line length (NLL). In one or more embodiments, the clearing distance is more precisely equal to an integer number of nozzle line lengths plus two times the internozzle distance (IND).

clearing space=i·NLL+2·IND

For example, in at least one embodiment, in which the first and second print heads 120, 122 each include a Model SE-128 head, each print head includes 128 nozzles and the internozzle distance (IND) is 508 μm. Therefore, the total nozzle line length (NLL) is 128-508 μm, which is 65.024 mm. The clearing distance in this case is set at the NLL plus 2-IND (or 130 times the internozzle distance (IND)), which is approximately 66.04 mm.

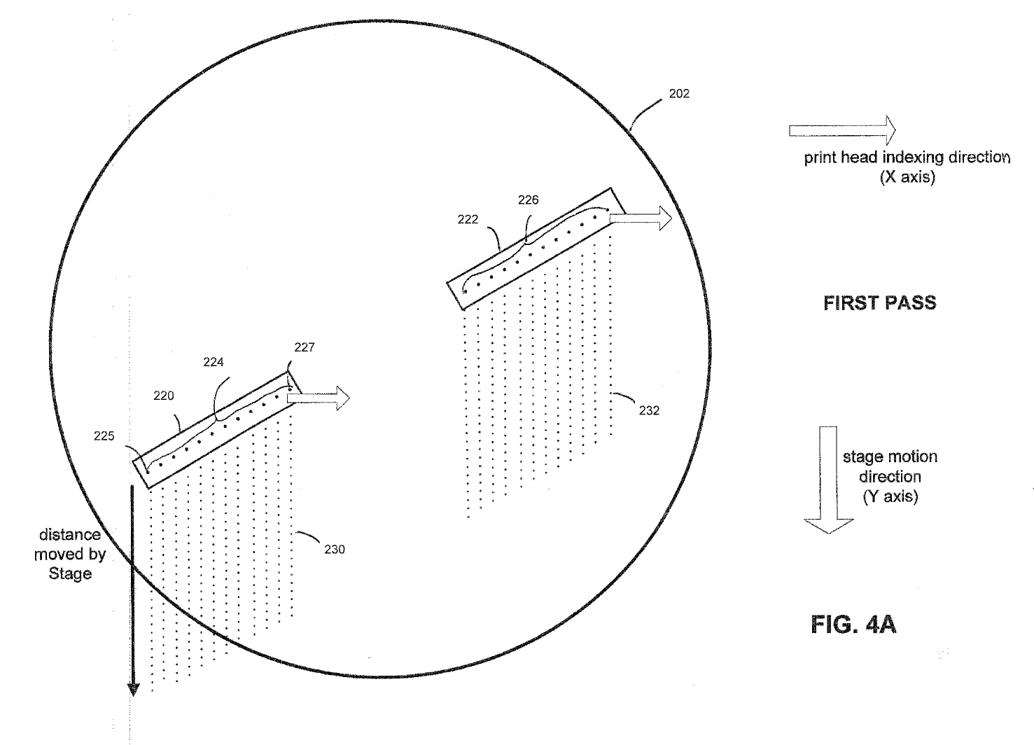

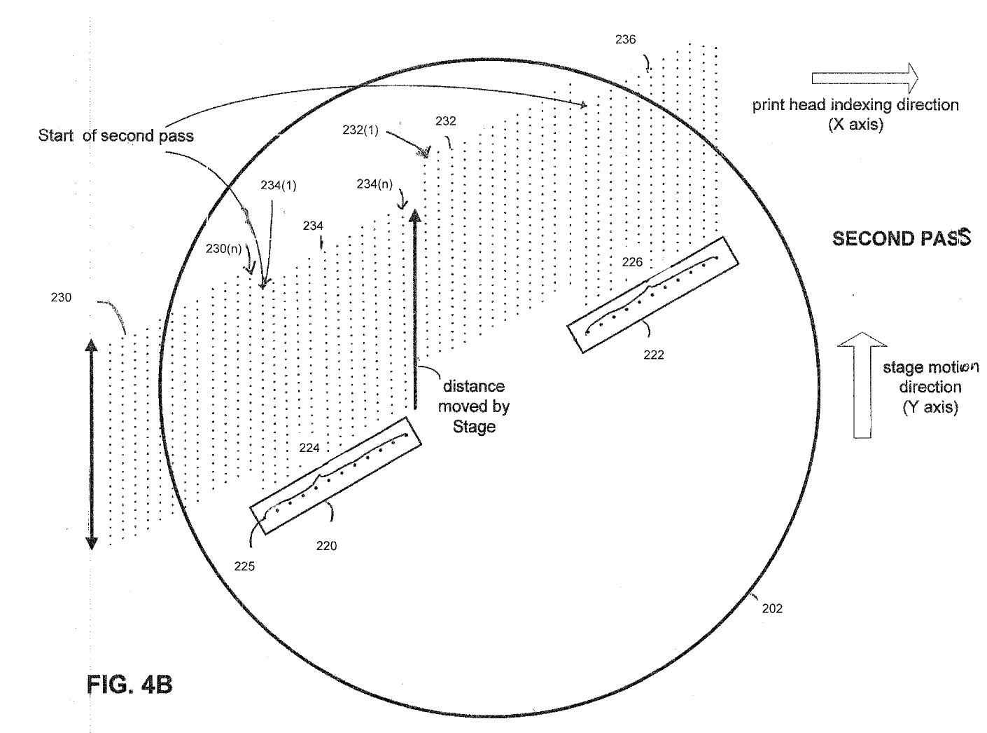

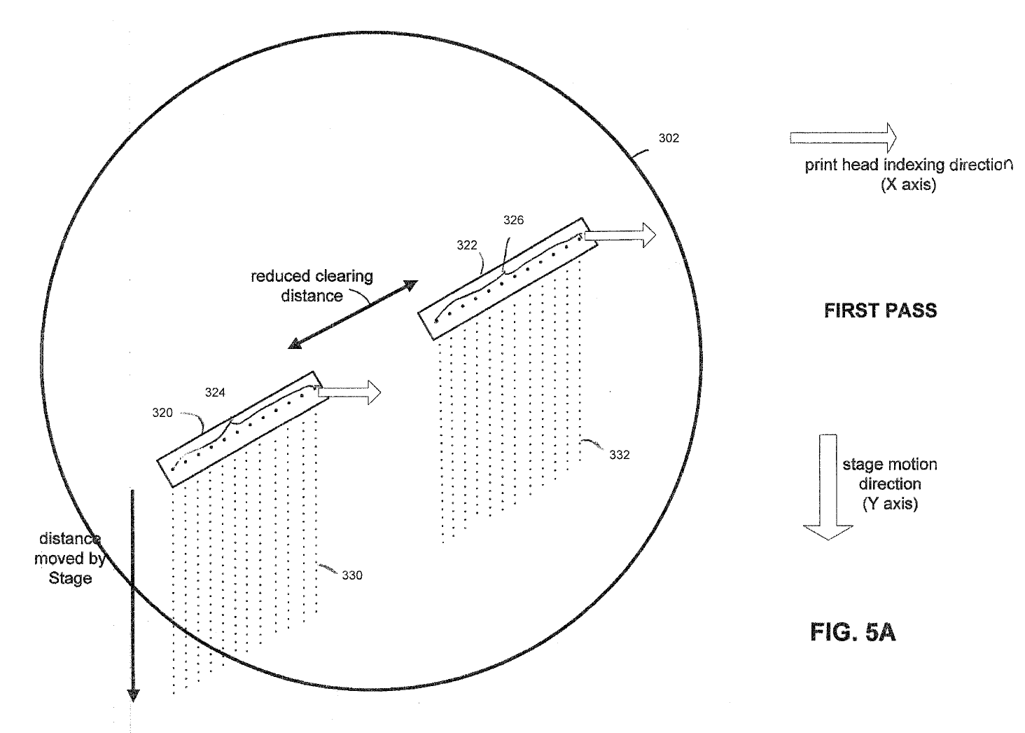

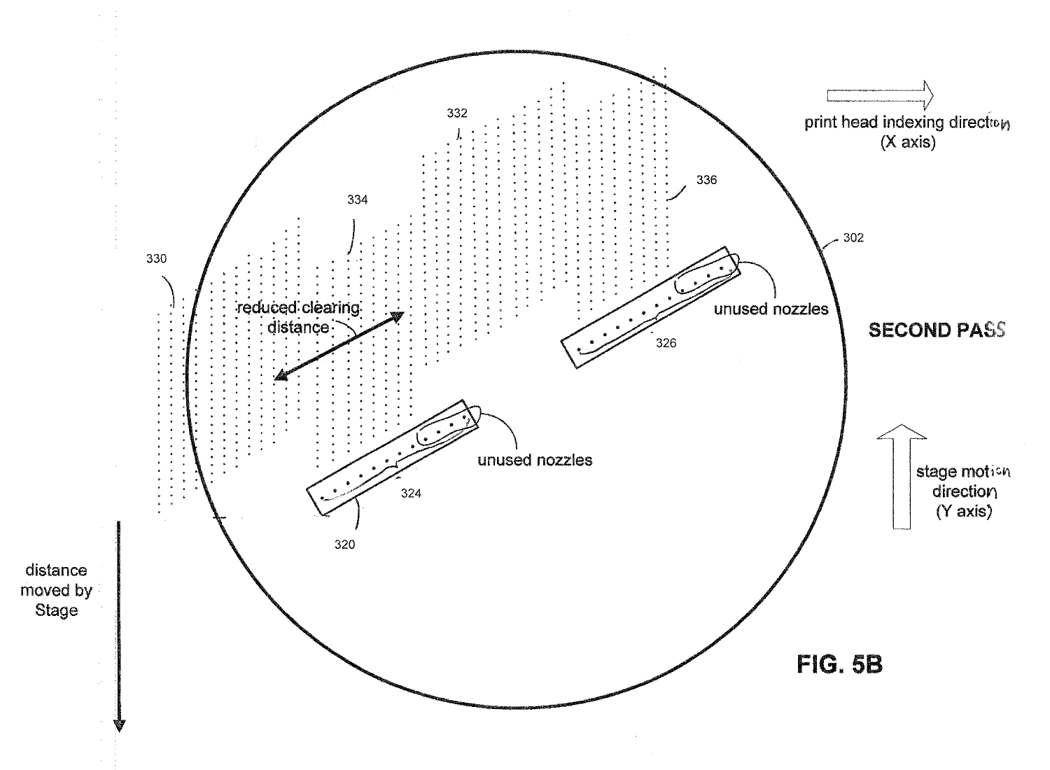

The clearing distance is set in order to facilitate achieving high throughput as is explained with reference to FIGS. 4A, 4B, 5A and 5B. FIG. 4A illustrates a first print pass of a print carriage 202 including two print heads 220, 222 having a clearing distance of one NLL plus 2·IND as in the embodiment shown in FIG. 3. In operation, first and second print heads 220, 222 print as the stage underneath moves the substrate in the negative Y-axis direction (downward) during a first printing pass. During the first pass, as the stage moves downwards, the respective nozzle sets 224, 226 of the first and second print heads 220, 222 jet at timed intervals, and print drops in rows inclined at the saber angle with respect to the X-axis in two separated areas 230, 232. The pitch, i.e., the horizontal distance along the X-axis between consecutive printed columns of drops, can be narrowed or widened, by adjusting the saber angle according to the relation:

pitch=cos Φ·IND

After the stage has moved a certain distance, the first print pass ends. The print head carriage 202 including first and second print heads 220, 222 is then moved, or indexed, in the positive X-axis direction as indicated. As shown in FIG. 4B, the print head carriage 202 is indexed a certain distance, such that the first nozzle 225 of the first print head 220 clears the column printed by the last nozzle 227 of the first print head 220 during the first print pass by one inter-nozzle distance (IND). Note that the distance is equal to the X-component of the clearing distance. In other words, the distance that the print head carriage is indexed is equal to the clearing distance projected onto the X-axis. In this manner, at the start of the next printing pass, the print head 220 will not print over the area 230 previously printed.

Once the print head carriage 202 has been indexed, the second print pass commences, which is illustrated in FIG. 4B. In one or more embodiments, the direction of stage motion in the second print pass may be the reverse of the direction in the first print pass. This is the case in the example second print pass of FIG. 4B, in which the stage moves the substrate in the positive Y-axis direction (e.g., upward in FIG. 4B). As in the first print pass, in the second print pass, as the stage moves upward a certain distance (which may be the same as the distance moved downward in the first pass as shown, or may be a different distance), the respective nozzle sets 224, 226 of the first and second print heads 220, 222 jet at timed intervals, and print drops in rows inclined at the saber angle with respect to the X-axis in two separated areas 234, 236. Additional print passes may also be performed to fill remaining sections of a given substrate such that, for example, another group of drops may be printed adjacent to printed area 236 on a side opposite from printed area 232.

As can be discerned from the illustration of FIG. 4B, the printed area 234 includes drops dispensed from all of the nozzles in the nozzle set 224 of the first print head 220 which fits seamlessly between the previously printed areas 230, 232. In particular, the distance between the last column 230(n) of printed area 230 and the first column 234(1) of print area 234 is equal to the inter-nozzle distance (IND) (taken along the saber angle orientation), and the distance between the last column 234(n) of print area 234 and the first column 232(1) of print area 232 is also equal to the to the inter-nozzle distance (IND) (taken along the saber angle orientation). Additionally, the printed areas 234 and 236 are equal in size to printed areas 230 and 232.

It is noted that both the completeness (in terms of the number of nozzles of the print heads used) and the seamlessness of the integration of the second print pass with the first print pass, is a result of the clearing distance between the first and second print heads 220, 222. Firstly, employing multiple print heads simultaneously can potentially increase throughput in proportion to the number of print heads employed. For example, a print carriage that includes two print heads may potentially double the throughput of a print carriage including only one print head by operating simultaneously. However, in the depicted example, to realize this potential, the spacing of the print heads on the print carriage are preferably set accordingly.

In the example shown, by setting the clearing distance equal to the nozzle line length (NLL) plus two inter-nozzle distances (IND) (the latter accounting for the spaces between the first and last columns 234(1), 234(n) of print area 234 and the print areas to which these columns are adjacent 230, 232), the amount of substrate area covered by the first and second print passes is maximized, thereby optimally boosting printing throughput. More generally, setting the clearing distance to an integer multiple of the nozzle line length (NLL) plus two inter-nozzle distances to provide end spacing maximizes throughput when employing multiple print heads during printing.

FIGS. 5A and 5B illustrate how the clearing distance between the print heads on a carriage affects throughput by illustrating the negative example of a sub-optimal clearing distance. FIG. 5A illustrates a first print pass of an exemplary print carriage 302 including first and second print heads 320, 322 similar to the first print pass illustrated in FIG. 4A. However, in the arrangement shown in FIG. 5A, the clearing distance between the first and second print heads 320, 322 is reduced in comparison to the clearing distance of the print heads 220, 222 illustrated in FIG. 4A. During the first print pass, in which the stage is moved in the negative Y-axis direction (downward), the respective nozzle sets 324, 326 of the first and second print heads 320, 322 jet at timed intervals, and print drops in rows inclined at the saber angle with respect to the X-axis in two separated areas 330, 332. As can be discerned, the areas printed in the first print pass 330, 332 are reduced in size compared to the areas 230, 232 shown in FIG. 4A, corresponding to the reduction in clearing distance between the print heads 320, 322.

FIG. 5B illustrates the second pass of the arrangement shown in FIG. 5A. After the print carriage 302 has indexed in the positive X-axis direction to clear printed areas 330, 332, the stage reverses direction and moves in the positive Y-axis direction (upwards) while print heads 320, 332 jet drops. As can be discerned, due to the reduced distance between printed areas 330, 332, there is insufficient space for an equal-sized area of drops to be printed between printed areas 330, 332. Thus, in order to avoid printing over previously dispensed drops, the print heads are controlled such that only a portion of the nozzles of nozzle sets 324, 326, are employed for jetting during the second print pass, with the remainder of nozzles being unused in the second print pass (as shown). A print pass in which a portion of the nozzles in a print head are unused is sub-optimal because fewer drops are being dispensed per unit time than would be the case if all the nozzles were being used. In some instances, however, such partial printing is either desired or unavoidable due to the dimensions of the substrate, surface features on the substrate, or other reasons. In these cases, some quantity of throughput rate may be sacrificed to meet other objectives.

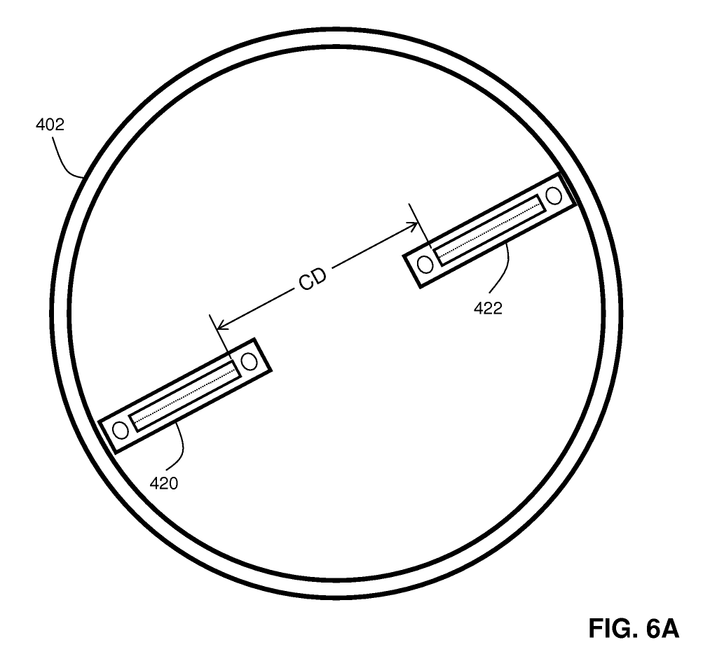

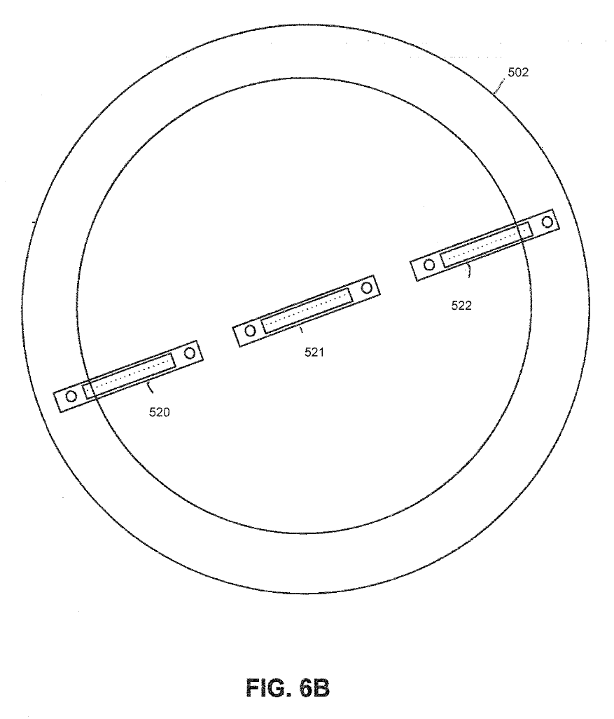

The foregoing description discloses only particular embodiments of the invention; modifications of the above disclosed methods and apparatus which fall within the scope of the invention will be readily apparent to those of ordinary skill in the art. For example, as noted above, in some embodiments, the clearing distance between multiple print heads on print carriage may be twice, three times, or approximately any integer multiple of the nozzle line length (NLL) of the print heads. As an example, FIG. 6A shows a bottom view of a print carriage 402 having first and second print heads 420, 422 in which the clearing distance CD between the first and second print heads 420, 422 is twice the nozzle line length (NLL) plus twice the inter-nozzle distance (IND).

In addition, a print carriage may include more than two print heads. For example, FIG. 6B shows a bottom view of a print carriage 502 including first, second and third print heads 520, 521, and 522. In the example depicted, the clearing distance between the first and second print heads 520, 521 is approximately equal to the nozzle line length (NLL) as is the clearing distance between the second and third print heads 521 and 522.

In yet other embodiments, the print heads may be staggered in the Y-direction so that the clearing distance may be set to zero. In such an embodiment, the lines of the nozzle sets are not aligned with each other and thus, the print heads are preferably disposed so that the point of rotation about which the saber angle is set, is centrally located between the print heads in both the X and Y directions.

In still yet other embodiments, print heads similarly disposed but on different print carriages may be employed to subsequently print rows of ink drops “seamlessly” between previously printed rows of ink drops by staggering the carriages on different print supports by an amount equal to the X-component of the clearing distance.

Further, the present invention may also be applied to spacer formation, polarizer coating, and nanoparticle circuit forming.

Accordingly, while the present invention has been disclosed in connection with exemplary embodiments thereof, it should be understood that other embodiments may fall within the spirit and scope of the invention as defined by the following claims.

The invention claimed is:

1. A printing apparatus comprising:
a platform adapted to rotate about a rotational axis; and
a plurality of longitudinally aligned print heads coupled to the platform.

2. The printing apparatus of claim 1, wherein each of the plurality of print heads includes a set of nozzles arranged in a line having a nozzle line length.

3. The printing apparatus of claim 2, wherein the print heads are separated longitudinally by a clearing distance equal to approximately an integer times the nozzle line length.

4. The printing apparatus of claim 2, wherein the sets of nozzles have a uniform inter-nozzle spacing distance and the print heads are separated longitudinally by a clearing distance equal to an integer times the nozzle line length plus twice the inter-nozzle spacing distance.

5. The printing apparatus of claim 1, wherein the plurality of longitudinally aligned print heads are disposed along a line that intersects the rotational axis.

6. The printing apparatus of claim 1, wherein the platform is coupled to a print carriage.

7. The printing apparatus of claim 7, wherein the print carriage is adapted to be suspended from and moveable along a print head support.

8. An inkjet printing system for manufacturing color filters comprising:
a frame;
a stage coupled to the frame and adapted to move a substrate in a print direction;
a print support coupled to the frame and adapted to support a plurality of print carriages, wherein the carriages are adapted to be moved along the print support;
a plurality of platforms, each one coupled to a different one of the print carriages and each adapted to rotate about a different respective rotational axis; and
a plurality of sets of print heads, each one of the sets coupled to a different one of the platforms and each set including a plurality of longitudinally aligned print heads.

9. The inkjet printing system of claim 8, wherein each of the plurality of print heads includes a set of nozzles arranged in a line having a nozzle line length.

10. The inkjet printing system of claim 9, wherein the print heads are separated longitudinally by a clearing distance equal to approximately an integer times the nozzle line length.

11. The inkjet printing system of claim 9, wherein the sets of nozzles have a uniform inter-nozzle spacing distance and the print heads are separated longitudinally by a clearing distance equal to an integer times the nozzle line length plus twice the inter-nozzle spacing distance.

12. The inkjet printing system of claim 8, wherein the plurality of longitudinally aligned print heads are disposed along a line that intersects the respective rotational axis.

13. The inkjet printing system of claim 8, wherein the plurality of carriages are adapted to be moved a distance equal to an X-component of a clearing distance between print passes.

14. A method of depositing ink on a substrate for manufacturing a color filter, comprising:
longitudinally aligning a plurality of print heads on a platform;
rotating the platform about a rotational axis to bring the print heads to a desired saber angle; and
depositing ink from the print heads in a first print pass on a substrate moving in a first print direction below the print heads.

15. The method of claim 14 wherein longitudinally aligning a plurality of print heads includes longitudinally aligning a plurality of print heads that each include a set of nozzles arranged in a line having a nozzle line length.

16. The method of claim 15 further comprising separating the print heads longitudinally by a clearing distance equal to approximately an integer times the nozzle line length.

17. The method of claim 15, wherein the sets of nozzles have a uniform inter-nozzle spacing distance and the method further comprising separating the print heads longitudinally by a clearing distance equal to an integer times the nozzle line length plus twice the inter-nozzle spacing distance.

18. The method of claim 14 further comprising shifting the platform a predefined distance in a direction perpendicular to the printing direction.

19. The method of claim 18 wherein shifting the platform a predefined distance includes shifting the platform a distance equal to an X-component of a clearing distance between the print heads.

20. The method of claim 19 wherein shifting the platform a distance equal to an X-component of a clearing distance between the print heads includes shifting the platform a distance equal to an X-component of a clearing distance equal to an integer times a nozzle line length plus twice an inter-nozzle spacing distance.

21. The method of claim 18 further comprising depositing ink from the print heads in a second print pass on the substrate moving in a second print direction below the print heads.

22. The method of claim 21 wherein depositing ink from the print heads includes depositing sets of rows of ink drops seamlessly between sets of rows of ink drops previously deposited on the substrate during the first print pass.
